(19) United States
(12) Patent Application Publication
(10) Pub. No.: US 2002/0100152 A1
(43) Pub. Date: Aug. 1, 2002

(54) Urn for pets

(76) Inventor: Judy Ortega, Culver City, CA (US)

Correspondence Address: Richard W. Goldstein, 2071 Clove Road, Staten Island, NY, 10304, US

(21) Appl. No.: 09/771,421

(22) Filed: Jan. 26, 2001

(51) Int. Cl. A61G 17/00

(52) U.S. Cl. 27/1

(57) ABSTRACT

An urn for pets including a container adapted for holding remains of a cremated animal therein. A figure resembling a deceased pet is provided. The figure has an internal cavity dimensioned for receiving the container therein.

### BACKGROUND OF THE INVENTION

The present invention relates to an urn for pets and more particularly pertains to housing the remains of a deceased pet.

Pet owners become very attached to their pets. They often feel that their pets are a part of their family similar to that of a child or sibling. When these pets die, the pet owners and their family often go through a grieving period. Pets that die are frequently buried in the backyard of the pet owner after undertaking a funeral-like ceremony. Some pet owners wish to have their pet cremated, to keep their ashes to cherish their memory. What is needed is a creative type of storage device that will allow the pet owner to keep the ashes of their deceased pet while also symbolizing the type and/or breed or their pet.

The present invention attempts to solve the abovementioned problem by providing a device that will hold the remains of a pet in a decorative figure.

The use of memorial devices is known in the prior art. More specifically, memorial devices heretofore devised and utilized for the purpose of memorializing deceased pets and the like are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,015,330 to Botsch discloses a personalized pet memorial comprised of a molded product with an inscribed image containing a shaped surface. U.S. Pat. No. 5,230,127 to Zukowski discloses a cremation urn with an indicator of the deceased pet incorporated therein. U.S. Pat. No. Des. 398,733 to Diviak, Sr. discloses the ornamental design for a pet urn.

While these devices fulfill their respective, particular objective and requirements, the aforementioned patents do not describe an urn for pets for housing the remains of a deceased pet.

In this respect, the urn for pets according to the present invention substantially departs from the conventional concepts and designs of the prior art, and in doing so provides an apparatus primarily developed for the purpose of housing the remains of a deceased pet.

Therefore, it can be appreciated that there exists a continuing need for new and improved urn for pets which can be used for housing the remains of a deceased pet. In this regard, the present invention substantially fulfills this need.

### SUMMARY OF THE INVENTION

In the view of the foregoing disadvantages inherent in the known types of memorial devices now present in the prior art, the present invention provides an improved urn for pets. As such, the general purpose of the present invention, which will be described subsequently in greater detail, is to provide a new and improved urn for pets which has all the advantages of the prior art and none of the disadvantages.

To attain this, the present invention essentially comprises a container adapted for holding remains of a cremated animal therein. A figure resembling a deceased pet is provided. The figure has an internal cavity dimensioned for receiving the container therein.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved urn for pets which has all the advantages of the prior art memorial devices and none of the disadvantages.

It is another object of the present invention to provide a new and improved urn for pets which may be easily and efficiently manufactured and marketed.

It is a further object of the present invention to provide a new and improved urn for pets which is of durable and reliable construction.

An even further object of the present invention is to provide a new and improved urn for pets which is susceptible of a low cost of manufacture with regard to both materials and labor, and which accordingly is then susceptible of low prices of sale to the consuming public, thereby making such an urn for pets economically available to the buying public.

Even still another object of the present invention is to provide a new and improved urn for pets for housing the remains of a deceased pet.

Lastly, it is an object of the present invention to provide a new and improved urn for pets including a container adapted for holding remains of a cremated animal therein. A figure resembling a deceased pet is provided. The figure has an internal cavity dimensioned for receiving the container therein.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the urn for pets constructed in accordance with the principles of the present invention.

### DESCRIPTION OF THE PREFERRED EMBODIMENT

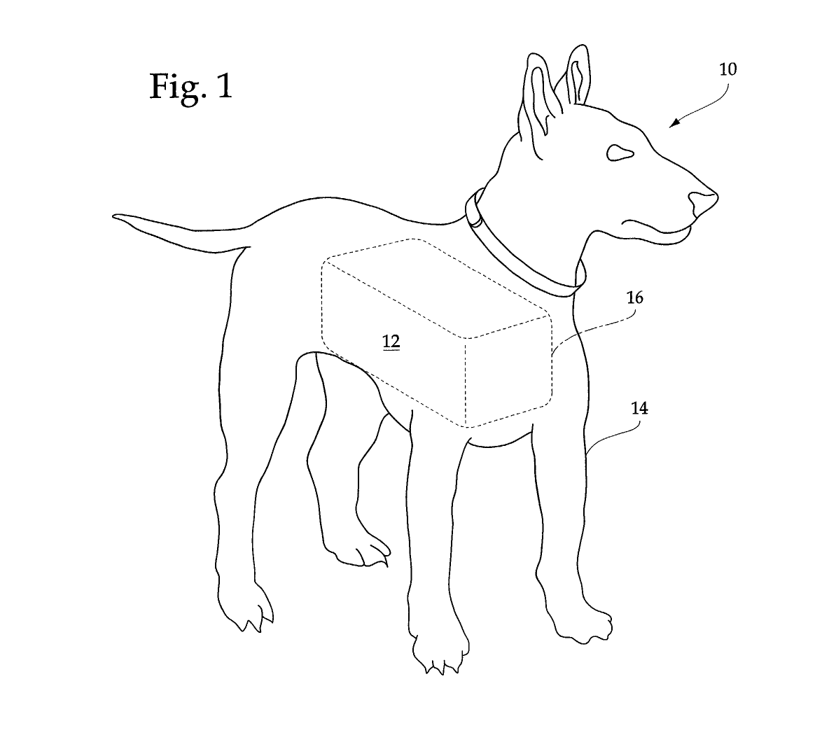

With reference now to the drawings, and in particular, to FIG. 1 thereof, the preferred embodiment of the new and improved urn for pets embodying the principles and concepts of the present invention and generally designated by the reference number 10 will be described.

Specifically, it will be noted in the various figures that the device relates to a urn for pets for housing the remains of a deceased pet. In its broadest context, the device consists of a container and a figure. Such components are individually configured and correlated with respect to each other so as to attain the desired objective.

The container 12 is adapted for holding remains of a cremated animal therein. The container 12, as noted in FIG. 1, is rectangular in shape. It should be noted, however, that this configuration is merely illustrative of the myriad of shapes and sizes that the container 12 could be designed. The container 12 could be designed with a lid that can be locked to prevent the remains from accidentally spilling.

The FIG. 14 resembles a deceased pet. The FIG. 14 has an internal cavity 16 dimensioned for receiving the container 12 therein. The FIG. 14 can be constructed of a number of different materials. Examples of such materials include, but are not limited to, ceramic or cloth exterior having a bean-bag interior. The FIG. 14 can be designed to match the breed of the pet, disposed in a particular position that will enhance the memory of the pet to the pet owner.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. An urn for pets for housing the remains of a deceased pet comprising, in combination:
a container adapted for holding remains of a cremated animal therein; and
a figure resembling a deceased pet, the figure having an internal cavity dimensioned for receiving the container therein.

2. The urn for pets as set forth in claim 1, wherein the figure is constructed of ceramics.

3. The urn for pets as set forth in claim 1, wherein the figure is constructed of a cloth exterior having a bean bag interior.
